(19) United States
(12) Patent Application Publication
(10) Pub. No.: US 2006/0084560 A1
(43) Pub. Date: Apr. 20, 2006

(54) Box forming mechanism & method

(76) Inventor: Pascal Martini, Le Poincorinet (FR)

Correspondence Address: MEADWESTVACO CORPORATION;LAW DEPARTMENT, 4850 NORTH CHURCH LANE, SUITE D, SMYRNA, GA, 30080, US

(21) Appl. No.: 11/208,088

(22) Filed: Aug. 19, 2005

Related U.S. Application Data
(63) Continuation of application No. PCT/US04/04865, filed on Feb. 19, 2004.

(30) Foreign Application Priority Data
Feb. 19, 2004 (GB) 0303738.9

(51) Int. Cl. B31F 7/00

(52) U.S. Cl. 493/438

(57) ABSTRACT

The invention disclosed is a mechanism and method for erecting a box from a foldable sheet material, such as paperboard. The mechanism comprises a first conveyor for receiving and conveying successive box blanks in a first generally horizontal plane and a second conveyor for receiving partially erected box blanks from the first conveyor and for completing the box forming in a second generally horizontal plane displaced vertically from said first horizontal plane. The first conveyor includes an inclined run extending towards the second conveyor during which inclined run successive box blanks are partially erected by successive transverse arms. Each of the arms cooperates with a box blank in the inclined run to fold the box blank so that it can be received and further folded by folding lugs provided by the second conveyor. The conveyor drives are coordinated so that the horizontal component of speed of the inclined run is synchronized with that of the second conveyor.

This is a continuation of international application No. PCT/US2004/004865, filed Feb. 19, 2004, which is hereby incorporated by reference

### BACKGROUND OF THE INVENTION

This invention relates to a mechanism and a method of erecting a box from a foldable sheet material, such as a paperboard blank.

The term “box” used herein is intended to include open ended sleeves and sleeves having one open end. Indeed, the invention is particularly useful for forming an insert that is a sleeve which has one open end to receive product which can then be received in some form of outer packaging.

### SUMMARY OF THE INVENTION

One aspect of the present invention provides a mechanism for erecting a box from a foldable sheet material, such as paperboard, which mechanism comprises a first conveyor for receiving and conveying successive box blanks in a first generally horizontal plane and a second conveyor for receiving partially erected box blanks from the first conveyor and for completing the box forming in a second generally horizontal plane displaced vertically from said first horizontal plane, and wherein the first conveyor includes an inclined run extending towards the second conveyor during which inclined run successive box blanks are partially erected by successive transverse folding means each of which cooperates with a box blank in the inclined run to fold the box blank so that it can be received and further folded by further folding means provided by the second conveyor, drive means being provided so that the horizontal component of speed of the inclined run is synchronized with that of the second conveyor.

According to a feature of this aspect of the invention, the transverse folding means comprise transverse arms which may be carried by an endless conveyor disposed alongside the first and second conveyors in a generally vertical plane.

According to another feature of this aspect of the invention, the inclined run may include support means which cooperate with successive transverse arms to fold successive box blanks in the inclined run into an L-shape as each box blank moves along the inclined run. In mechanisms where this feature is adopted, the support means may comprise fixed rail means disposed intermediate conveying elements of the inclined run.

According to yet another feature of this aspect of the invention, the second conveyor may comprise an endless series of spaced upstanding lugs and wherein the movement of the conveying elements of the inclined run and that of the transverse arms is synchronized with movement of the upstanding lugs to deliver each partially erected box blank into the space between a successive pair of said upstanding lugs to fold the blank generally into a channel shape.

According to a still further feature of this aspect of the invention, conveying elements of the inclined run and the transverse arms which are cooperating with box blanks in the inclined run may move in parallel paths.

According to yet another feature of this aspect of the invention, fixed folding means may be provided adjacent the second conveyor to fold end panel means of each partially erected box blank as it is delivered to the second conveyor.

Preferably, further folding means are provided in cooperation with the second conveyor to fold an upstanding panel of each box blank present in the second conveyor towards and parallel to the second conveyor.

It is also preferable that ejector means are provided to eject successive erected boxes from the second conveyor.

Another aspect of the invention provides a method of erecting a box from a foldable sheet material, such as paperboard, which method comprises delivering successive box blanks to a first conveyor and conveying said blanks in a generally horizontal plane to a second conveyor, causing the blanks in the first conveyor to move through an inclined run of the first conveyor and to be engaged by transverse folding means which cooperate with the inclined run to partially fold the box blanks therein, causing the partially folded box blanks to be delivered from the inclined run to said second conveyor displaced vertically from said first conveyor and completing the folding of the box blanks as they are received by the second conveyor, drive means being provided to cause a horizontal component of movement of conveying means of the inclined run and of the second conveyor to be synchronized.

### BRIEF DESCRIPTION OF THE DRAWINGS

A mechanism and method of erecting a box from a paperboard blank, embodying the invention, will now be described, by way of example only, with reference to the accompanying drawings, in which:

FIG. 1 is a perspective view of a mechanism according to the invention, as seen from above and to one side, and

FIG. 2 is a schematic side view of the mechanism showing movement of the conveyors.

### DETAILED DESCRIPTION OF THE PREFERRED EMBODIMENTS

Referring to the drawings, the mechanism comprises three main modules; a first conveyor 10, a second conveyor 12 and an intermediate conveyor 14.

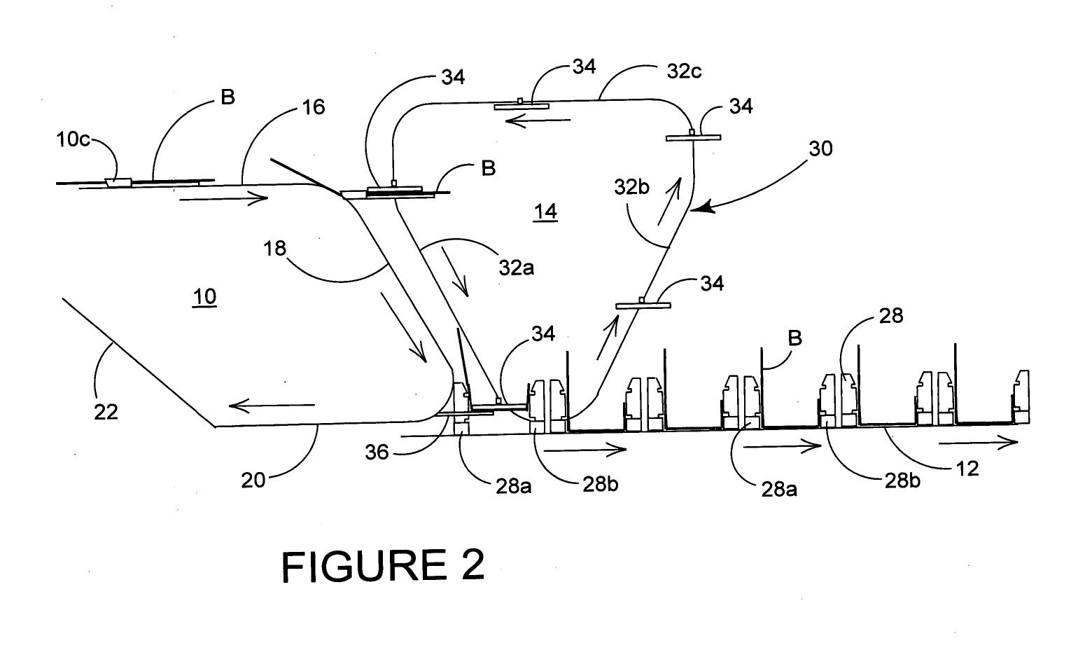

The first conveyor 10, which has a generally trapezoidal construction, comprises a pair of spaced endless conveyors 10a, 10b on which a series of spaced lugs 10c, 10d respectively is carried. The first conveyor has an upper working run 16 disposed in a generally horizontal plane, an inclined working run 18 and return runs 20 and 22 (FIG. 2). The upper run 16 receives box blanks in flat form from a supply (not shown).

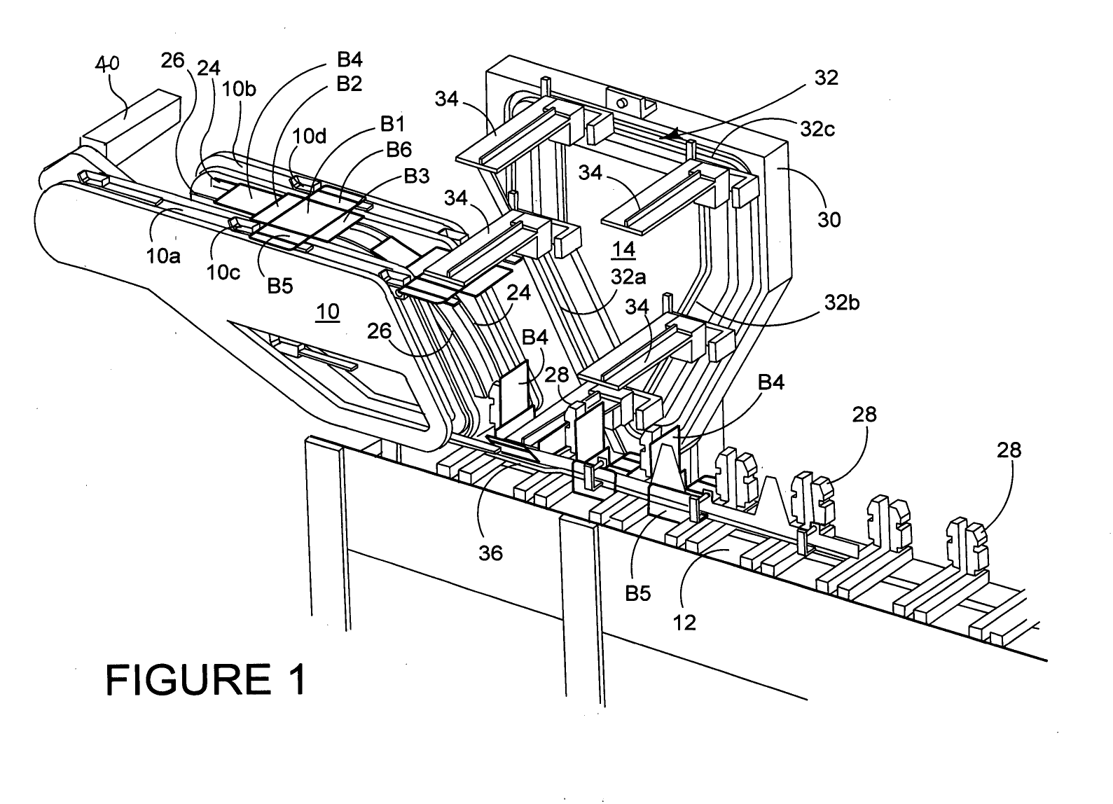

In this particular embodiment, each box blank ‘B’ has a number of mutually foldable panels as follows: a base panel B1, side wall panels B2, B3, a top panel B4 and end closure panels B5 and B6 respectively (FIG. 1, upper run).

When a blank is received on the upper run it has panels B1, B3 and B4 supported by a pair of fixed support rails 24, 26 disposed between conveyors 10a, 10b (FIG. 1) whereas the end closure panels B5, B6 are supported by the spaced moving conveyors 10a, 10b and engaged by the conveyor lugs 10c, 10d.

In the inclined run the fixed support rails 24, 26 are progressively arcuate out of the plane containing the conveyors 10a, 10b in a direction towards conveyor 12. The second conveyor 12 has an endless series of upstanding lugs 28 which move from left to right, in a generally horizontal plane as seen in the drawings. Juxtaposed pairs of lugs, e.g., lugs 28a and 28b are adjustably spaced apart and provide a former into which partially erected box blanks from the inclined run 18 are inserted.

In order to effect positive transfer of partially erected box blanks from the inclined run 18 to the second conveyor 12, an intermediate transfer conveyor 14 is provided. The intermediate transfer conveyor comprises an upright frame 30 which is disposed alongside the second conveyor adjacent the inclined run of the first conveyor 10. In construction, the intermediate transfer conveyor resembles an inverted open-faced arrowhead in which an endless conveyor 32 carries a series of flat plate transverse arms 34. The conveyor 32 and hence the transverse arms have a working run 32a, a retracting run 32b and a return run 32c and the transverse arms are sized so that at some point in the operation of the intermediate transfer conveyor, the transverse arms extend over the inclined run 18 and/or the second conveyor 12.

In operation of the mechanism as a whole, the first and second conveyors move in a clockwise motion whereas the intermediate transfer conveyor moves in an anti-clockwise direction so that the transverse arms interfere with the movement of box blanks.

Each box blank is delivered to and conveyed by the lugs 10c, 10d of the upper run conveyors 10a, 10b into the inclined run 18 where it is first engaged by one of the transverse arms 34 at the upper end of the inclined run 18. The working run 32a of conveyor 14 is parallel to that of the inclined run 18 and moves at the same speed so that as the engaged transverse arm moves downwards and forwards the horizontal box blank is folded against the fixed supports 24, 26 into a generally L-shaped configuration. More specifically, each transverse arm 34 engages the base panel B1 and the end closure panels B6 of a blank. Thus, the upright limb of the L-shape comprises side panel B2 and top panel B4 whereas the horizontal limb of the L-shape comprises the remaining panels of the blank of which panels B3 (forwards) and B5 (sideways) extend beyond the engaging face of the transverse arm 34.

Whereas the rotational speeds of the conveyors 10 and 14 are matched so that successive transverse arms engage successive box blanks, the speeds of horizontal components of their inclined working runs 18 and 32a, respectively, are synchronized with the speed of the second conveyor 12 by controlling means (such as a servo motor 40 in FIG. 1) for controlling the speed of the conveyors 10 and 14 and/or that of the conveyor 12.

In this way, each successive transverse arm is able to locate between successive juxtaposed pairs 28a, 28b of upright lugs of the second conveyor and in so doing the partially formed box blank is further folded as it is pushed downwardly into the space between the juxtaposed lugs to form a generally channel shape. Thus, base panel B1 overlies the conveyor 12, side wall panel B3 is disposed upright against the leading lug 28b and side wall panel B2 together with top panel B4 is disposed upright against the trailing lug 28a. During this folding operation, a fixed guide 36 located alongside conveyor 12 in the path of movement of end closure panels B5 causes those panels to be folded upwardly to close one end of the channel form of the box blank. At or about the completion of this folding sequence, the engaged transverse arm begins to retract from engagement between juxtaposed lugs 28a, 28b moving upwardly and forwardly in the retracting run 32b in which the horizontal component of speed of conveyor 30 is synchronized with that of conveyor 12.

In order to complete the folding operation to provide a fully formed insert, a rotatable folder (not shown) may be provided above conveyor 12 to knock down the top panel B4 of the blank to form a sleeve with one open end facing the intermediate transfer conveyor 14. Thereafter, successive inserts may be ejected from the mechanism by suitable means, for example, transversely reciprocal pushers (not shown) which may be cam guided in their operation, and the ejected inserts then filled with product for further processing.

What is claimed is:

1. A mechanism for erecting a box from a foldable sheet material, the mechanism comprising a first conveyor for receiving and conveying successive box blanks in a first generally horizontal plane and a second conveyor for receiving partially erected box blanks from the first conveyor and for completing the box forming in a second generally horizontal plane displaced vertically from said first horizontal plane, and wherein the first conveyor includes an inclined run extending towards the second conveyor, the mechanism further comprising successive transverse folding means for partially erecting successive box blanks in the inclined run, each of the successive transverse folding means cooperating with a box blank in the inclined run to fold the box blank so that the box blank is received and further folded by further folding means provided by the second conveyor, and controlling means for controlling the speed of the inclined run so that the horizontal component of speed of the inclined run is synchronized with that of the second conveyor.

2. A mechanism according to claim 1 wherein the transverse folding means comprises transverse arms carried by an endless conveyor disposed alongside the first and second conveyors in a generally vertical plane.

3. A mechanism according to claim 1 wherein the inclined run includes support means which cooperate with successive transverse arms to fold successive box blanks in the inclined run into an L-shape as each box blank moves along the inclined run.

4. A mechanism according to claim 3 wherein the support means comprises fixed rail means disposed intermediate conveying elements of the inclined run.

5. A mechanism according to claim 2 wherein the second conveyor comprises an endless series of spaced upstanding lugs and wherein the movement of the conveying elements of the inclined run and that of the transverse arms is synchronized with movement of the upstanding lugs to deliver each partially erected box blank into the space between a successive pair of said upstanding lugs to fold the blank generally into a channel shape.

6. A mechanism according to claim 2 wherein conveying elements of the inclined run and the transverse arms which are cooperating with box blanks in the inclined run move in parallel paths.

7. A mechanism according to claim 1 wherein fixed folding means are provided adjacent the second conveyor to fold end panel means of each partially erected box blank as it is delivered to the second conveyor.

8. A mechanism according to claim 1 wherein further folding means are provided in cooperation with the second conveyor to fold an upstanding panel of each box blank present in the second conveyor towards and parallel to the second conveyor.

9. A mechanism according to claim 1 wherein ejector means are provided to eject successive erected boxes from the second conveyor.

10. A method of erecting a box from a foldable sheet material, such as paperboard, which method comprises delivering successive box blanks to a first conveyor and conveying said blanks in a generally horizontal plane to a second conveyor, causing the blanks in the first conveyor to move through an inclined run of the first conveyor and to be engaged by transverse folding means which cooperate with the inclined run to partially fold the box blanks therein, causing the partially folded box blanks to be delivered from the inclined run to said second conveyor displaced vertically from said first conveyor and completing the folding of the box blanks as they are received by the second conveyor, drive means being provided to cause a horizontal component of movement of conveying means of the inclined run and of the second conveyor to be synchronized.
